(19) United States
(12) Patent Application Publication
(10) Pub. No.: US 2016/0129657 A1
(43) Pub. Date: May 12, 2016

(54) PROCESS FOR MAKING A ROLLED EDGE TRAY

(71) Applicant: The Procter & Gamble Company, Cincinnati, OH (US)

(72) Inventors: Doug David GREEN, Iowa City, IA (US); Adam Wesley GIELAU, Cincinnati, OH (US); Kevin Eugene LANGTIMM, Solon, IA (US)

(21) Appl. No.: 14/850,097

(22) Filed: Sep. 10, 2015

Related U.S. Application Data
(60) Provisional application No. 62/048,602, filed on Sep. 10, 2014.

(51) Int. Cl. B31B 3/26; B31B 3/60; B65D 5/02

(52) U.S. Cl. CPC B31B 3/26; B65D 5/02; B31B 3/60; B31B 2201/26; B31B 2201/6008; B31B 2201/6052; B31B 2203/106

(57) ABSTRACT

The present invention is directed to a process for making a tray comprising modifying a blank having a flat edge wherein a rolled edge blank is made by folding a major panel and a minor panel and affixing to the inside of the blank and assembling the tray by running the rolled edge blank on tray forming equipment.

### FIELD OF THE INVENTION

The present invention relates to a process for making a tray with a rolled edge which can be manufactured at an improved rate with less material.

### BACKGROUND OF THE INVENTION

Various types of trays have been produced which may be erected from a flat blank and locked in erected form without the need for a securing material or device such as glue. This may be done by providing corner flaps on the ends of two opposed walls designed to fold into face contact with the inner surfaces of the opposed walls, and folding a panel to the upper edges of the other opposed walls inwardly of the corner flanges and locking the panel in this position. This process is typically manual and done at a slower rate than conventional automated tray forming.

The current conventional trays have an acute edge, exposing the corrugated flute. This enables high speed automation required by conventional lines, but presents the same appearance as trays used to shelve canned vegetables etc. Retailers require a premium tray (rolled edge) for many products, such as beauty products. Traditionally, these trays as described in the previous paragraph require manual forming and assembly at a significant cost increase over the current, less premium, automated solution.

The present invention consists of pre folding of a tray to give the desired finish look. Then the pre folded trays can be produced at a rate without modification to a traditional casepacker. The present invention further will provide an improved rate with less material than the current manual tray forming.

These, and other objects, will become readily apparent from the detailed description below.

### SUMMARY OF THE INVENTION

In an embodiment, the present invention, is directed to a process for making a tray comprising modifying a blank having a flat edge wherein a rolled edge blank is made by folding a major panel and a minor panel and affixing to the inside of the blank and assembling the tray by running the rolled edge blank on tray forming equipment.

### BRIEF DESCRIPTION OF THE DRAWINGS

FIG. 1A is a side 1 view of a blank of one embodiment of the present invention before the rolling of the blank edges.

FIG. 1B is a side 2 view of a blank of one embodiment of the present invention before the rolling of the blank edges.

FIG. 2A is a side 1 view of one embodiment of the present invention after the rolling of the blank edges.

FIG. 2B is a side 2 view of one embodiment of one embodiment of the present invention after the rolling of the blank edges.

FIG. 3 is a perspective view of one embodiment of the present invention after the full assembly of the tray in automated tray forming equipment.

### DETAILED DESCRIPTION OF EMBODIMENTS OF THE INVENTION

All measurements are understood to be made at ambient conditions, where “ambient conditions” means conditions at about 25° C., under about one atmosphere of pressure, and at about 50% relative humidity, unless otherwise designated. All numeric ranges are inclusive of narrower ranges; delineated upper and lower range limits are combinable to create further ranges not explicitly delineated.

As used herein, “consisting essentially of” means that the composition or component may include additional ingredients, but only if the additional ingredients do not materially alter the basic and novel characteristics of the claimed compositions or methods.

All percentages are by weight, unless stated otherwise. All ratios are weight ratios, unless specifically stated otherwise. All ranges are inclusive and combinable. The number of significant digits conveys neither a limitation on the indicated amounts nor on the accuracy of the measurements.

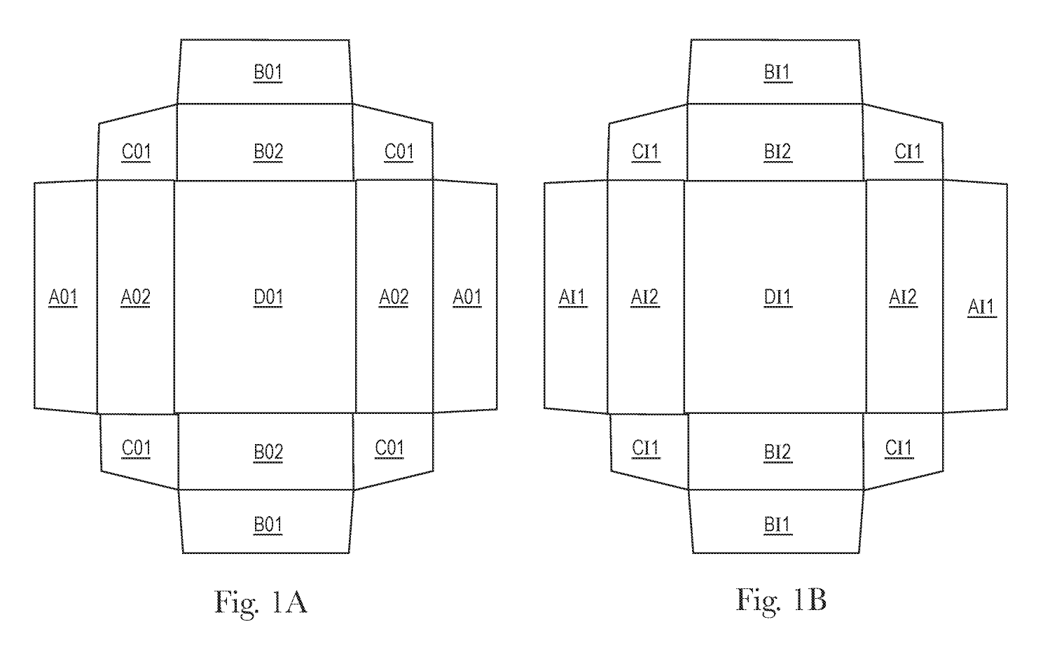

FIG. 1A and FIG. 1B illustrate a blank used to construct a tray with side 1 panels described by the figure references “AO”, “BO”, “CO”, “DO” and side 2 panels described by the figure references “AI”, “BI”, “CI”, “DI”. “A” designated panels are the major panels. “B” designated panels are the minor panels. “C” designated panels are the securing flaps that secure the “A” and “B” panels together. “D” designated panels are the base of the tray. Side 1 panels are, in general, the “outside” of the tray that is in contact with a store shelf and visible to a consumer in a store. Side 2 panels are, in general, the “inside” of the tray that is in contact with products.

In an embodiment of the present invention, the blank in FIG. 1A and FIG. 1B may be produced from, non-limiting examples, such as corrugated board, corrugated plastic, carton board, and any other conventional material.

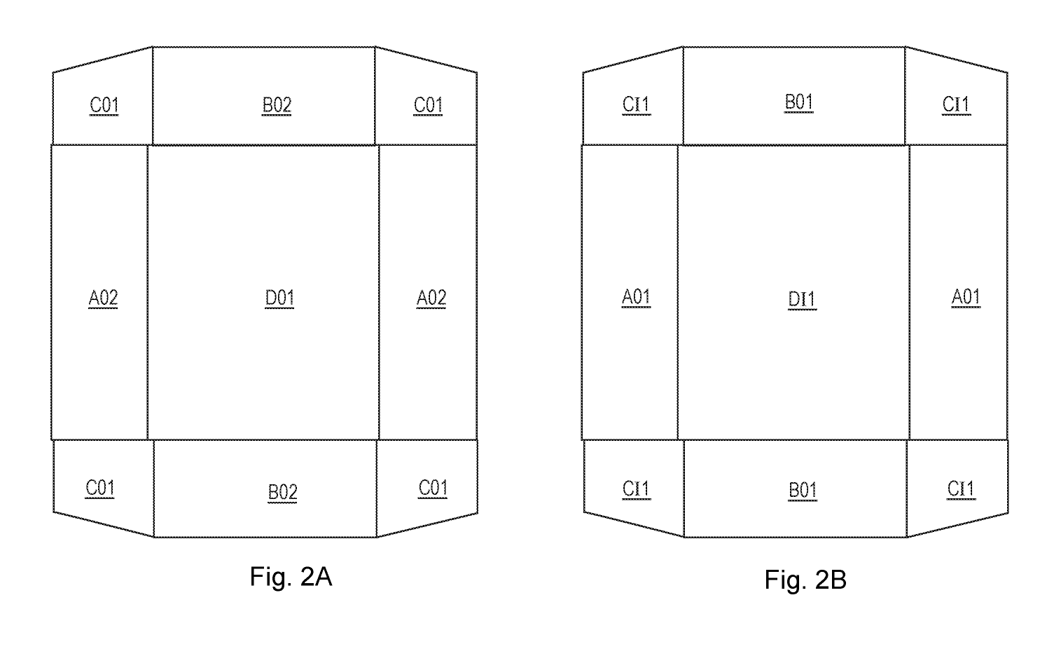

FIG. 2A and FIG. 2B illustrate the embodiment of the present invention of prefolding and affixing the A and B flaps. Referencing FIG. 1B and FIG. 2B Inside View, the following process is executed in any order:

1. Both All panels are folded and affixed to panel AI2 by any means to achieve a strong and secure bond, with such non-limiting examples as glue, hot melt, staples, or any other suitable adhering substance or mechanism. After the panels are affixed to each other, the AO1 panel demonstrates on FIG. 2B Inside View for both major panels.

2. Both BI1 panels are folded and affixed to panel BI2. After the panels are affixed to each other, the BO1 panel demonstrates on FIG. 2B Inside View for both minor panels.

3. The side 1 edges of the AO1 & AO2 panels, as well as the side 1 edges of the BO1 and BO2 panels are now rolled edges.

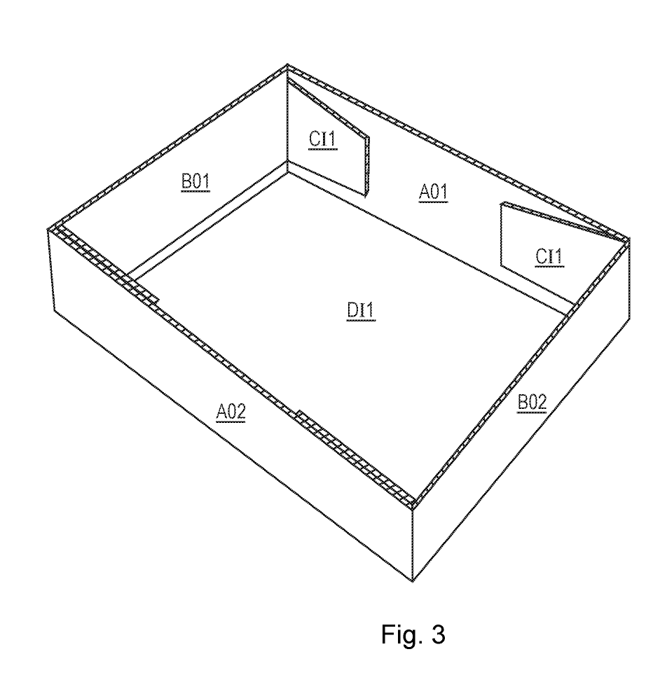

FIG. 3 illustrates the embodiment of the present invention in tray assembly. Referencing the FIG. 2B Inside View, the following is executed in any conventional tray forming equipment to complete the tray assembly process in any order.

1. Both BO1 panels are raised so that they are generally perpendicular to the panel DI1.

2. All four CI1 panels are folded towards the inside of the tray so that they are generally perpendicular to both the DI1 and BO1 panels.

3. Both AO1 panels are raised so that they are generally perpendicular to the both the DI1 and BO1 panels and generally parallel with the CI1 panels.

4. Both AO1 panels are affixed to the four CI1 panels by any means to achieve a strong and secure bond in the assembled tray, with such non-limiting examples as glue, hot melt, staples, or any other suitable adhering substance or mechanism.

5. The tray is now complete, with the FIG. 3 illustrating the rolled edges on the top edges of the AO1, AO2, BO1, and BO2 panels.

In an embodiment, the forming tray process represents an improvement over the existing technology in that the tray can be pre folded and loaded on one machine. The blank shown in

FIG. 1 of the present invention uses less material, a nonlimiting example being corrugated board, wherein a range of about 10% to about 25% less material is used than the traditional rolled edge tray, or in an embodiment in a range of about 15% to about 20% less material is used.

In a further embodiment of the present invention, the rate of manufacture of a tray is increased by greater than about 500% than the traditional rolled edge tray. In an embodiment, the present invention rate for manufacture of a tray is in the range of about 3 seconds vs. about 15 seconds for a manual tray formation.

In an embodiment, the forming tray process may form a symmetrical tray. In a symmetrical tray, the height of each wall or panel of the tray is equal or the same. In an embodiment, the symmetrical tray height for a wall may be about 50% or lower (or less) of the package in the tray. In an embodiment, the symmetrical tray height for a wall or panel may be about 40% or lower (or less) of the package in the tray. In an embodiment, the symmetrical tray height for a wall or panel may be about 30% or lower (or less) of the package in the tray. In an embodiment, the symmetrical tray height for a wall or panel may be about 20% or lower (or less) of the package in the tray. In an embodiment, the symmetrical tray height for a wall or panel may be about 10% or lower (or less) of the package in the tray.

In an embodiment, the forming tray process may form a non-symmetrical tray. In an embodiment, a non-symmetrical tray may have at least one wall or panel that is about 50% or lower (or less) of the total height of the package(s) in the tray and at least one wall or panel that is between about 50% and about 125% of the overall height for the package(s) in the tray. In an embodiment, a non-symmetrical tray may have at least one wall or panel that is about 40% or lower (or less) of the total height of the package(s) in the tray and at least one wall or panel that is between about 40% and about 125% of the overall height for the package(s) in the tray. In an embodiment, a non-symmetrical tray may have at least one wall or panel that is about 30% or lower (or less) of the total height of the package(s) in the tray and at least one wall or panel that is between about 30% and about 125% of the overall height for the package(s) in the tray. In an embodiment, a non-symmetrical tray may have at least one wall or panel that is about 20% or lower (or less) of the total height of the package(s) in the tray and at least one wall or panel that is between about 20% and about 125% of the overall height for the package(s) in the tray. In an embodiment, a non-symmetrical tray may have at least one wall or panel that is about 10% or lower (or less) of the total height of the package(s) in the tray and at least one wall or panel that is between about 10% and about 125% of the overall height for the package(s) in the tray.

In an embodiment, a non-symmetrical tray may include a tray wherein two sides of the tray or two panels may be angled from the height of a front wall to the height of a back wall of a tray. In an embodiment, two or more cartons of packages may sit on top of one another in the same tray. In such an embodiment, this provides from stacking of multiple packages or products on top of each other in a tray.

In an embodiment, some of the benefits of a non-symmetrical tray may be that it provides aid in shipping, by allowing the tray to take the load of the trays above rather than the package or product in the tray. A further benefit may be that a non-symmetrical tray provides aid or improvement in the movability of the trays in re-stacking or placement of the trays by keeping the product in the tray more stable. A further benefit may be that a non-symmetrical tray may provide high walls or panels which provide a billboard for advertising in the tray.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1) A process for making a tray comprising:
a) modifying a blank having a flat edge wherein a rolled edge blank is made by folding a major panel and a minor panel and affixing to the inside of the blank; and
b) assembling the tray by running the rolled edge blank on tray forming equipment.

2) The process according to claim 1 wherein the rate of manufacture is increased by greater than about 500%.

3) The process according to claim 1 wherein about 10% to about 25% less material is required to make a tray vs. a manual assembly of tray.

4) The process according to claim 1 wherein the major panel and minor panel are affixed to the inside of the blank by using glue, hot melt, staples and mixtures thereof.

5) The process according to claim 1 wherein the blank is made of a material selected from the group consisting of corrugated board, corrugated plastic, carton board and mixtures thereof.

6) The process according to claim 1 wherein a height of each panel and/or a wall of the tray is equal.

7) The process according to claim 6 wherein the height of a panel and/or a wall is about 50% or lower of a package in the tray.

8) The process according to claim 1 wherein a height of at least one panel and/or wall is about 50% or lower of the total height of a package(s) in the tray and at least one panel and/or wall is between about 50% and about 125% of the overall height for the package(s) in the tray.

9) The process according to claim 8 wherein two panels and/or walls may be angled from the height of a front wall to the height of a back wall of the tray.

10) A tray made by the process according to claim 1.
